(19) United States
(12) Patent Application Publication
(10) Pub. No.: US 2003/0162556 A1
(43) Pub. Date: Aug. 28, 2003

(54) Method and system for communication between two wireless-enabled devices

(76) Inventor: Michael A. Libes, Seattle, WA (US)

Correspondence Address: KATHLEEN THOMAS PETRICH, STOKES LAWRENCE, P.S., 800 FIFTH AVENUE, SUITE 4000, SEATTLE, WA, 98109, US

(21) Appl. No.: 10/087,536

(22) Filed: Feb. 28, 2002

(51) Int. Cl. H04B 5/00; H04B 7/00; H04Q 7/20

(52) U.S. Cl. 455/507; 455/517; 455/41

(57) ABSTRACT

A method and system of providing primary or secondary wireless communications between two wireless-enabled devices capable of communication via a wireless network, where one device is capable of transmitting and receiving data and the other device is at least capable of receiving data. Each wireless-enabled device includes a wireless handshake plug that is capable of transmitting and receiving data. When the two plugs are brought into physical proximity of each other, whether by direct contact, proximal contact, magnetic contact, very short-range, radio-frequency contact, or human contact, an communication link is established such that the one plug can transmit handshaking data to the other plug in what is called wireless handshaking apart from the wireless network. When the method is used for secondary wireless communication, the two plugs transmit enough handshaking data to establish if the devices are communications compatible apart from the wireless network. Once the plugs signal successful compatibility, the devices establish the wireless connection and the wireless handshaking terminates in lieu of the primary wireless communication.

### TECHNICAL FIELD

The present invention relates generally to establishing a wireless communication connection between two wireless-enabled devices through wireless handshaking.

### BACKGROUND OF THE INVENTION

Wireless technology has become standard in our fast-paced, frenetic world. Wireless devices, such as cell phones, small digital devices, PDA's, wireless keyboards, handheld game devices, etc. are prolific in our everyday lives, and are likely to be even more so in the near future. Inherently, wireless devices communicate over a radio-frequency network. Cellular phones tend to establish communication links with each other with little problem. But the connection of two wireless-enabled devices, such as two masters (computer to PDA) or a master and peripheral (PDA to a wireless printer) is often difficult and sometimes impossible, especially on an ad hoc network. If the devices are compatible, that is having the same wireless capabilities, the connection between the two devices can still take experts 10 minutes or more to configure the devices so that they can communicate with each other. And the average consumer/user can have hours of frustration attempting to connect such wireless devices. Now that wireless devices are endemic in the mainstream population, let alone the tech world, connection of these peripheral devices must become easier and faster. The wireless device industry is seeking solutions to this problem, of which the present invention is designed to address.

### SUMMARY OF THE INVENTION

The present invention is related to a method and system for wireless communication comprising providing two wireless-enabled devices. Each said wireless-enabled device includes a wireless handshake plug. Each said plug is capable of receiving and sending data to the other plug. The two wireless-enabled devices are “handshaked” such that the plug on each device is brought within physical proximity of the other. Thus, data is transmitted from one plug to the other to establish a wireless communication.

In an alternate method, the wireless-enabled devices have an inherent primary method of wireless communication over a wireless network. The wireless handshaking, as described above, is terminated once the wireless handshake plugs have established communication and the primary method of wireless communication over the wireless network has been activated. Thus, the method acts as a secondary communication link between the two wireless-enabled devices.

The present invention also includes a secondary system of communication between two wireless-enabled devices. The system includes a wireless network and two wireless-enabled devices, each device being capable of wireless communication over the wireless network. Each wireless-enabled device includes a wireless handshake plug that is capable of transmitting and receiving data when brought into physical proximity with the other apart from the wireless network.

### BRIEF DESCRIPTION OF THE DRAWINGS

Like reference numerals are used to designate like parts throughout the several views of the drawing, wherein:

FIG. 1 is a schematic view of a master wireless-enabled device capable of transmitting and receiving data and having a wireless handshake plug;

FIG. 2 is a schematic view showing a master wireless-enabled device having a wireless handshake plug about to be brought into physical proximity with a peripheral wireless-enabled device (keyboard or printer), each also having a wireless handshake plug;

FIG. 3 is a schematic view of two master wireless-enabled devices, each having a wireless handshake plug shown being brought into physical contact during handshaking and then transmitting data between the two devices;

FIG. 4 is an enlarged top plan view of the wireless handshake plugs on the two master devices of FIG. 3 about to be brought into physical proximity with the other;

FIG. 5 is a view like FIG. 4, except that the two wireless handshake plugs are brought into physical proximity during handshaking according to one embodiment of the present invention;

FIG. 6 is a schematic view of a user's hand making contact with a wireless handshake plug of a first device in a first alternate embodiment of wireless handshaking;

FIG. 7 is as schematic view of the user completing the communications link for wireless handshaking by having the user's other hand touching the other plug on the second device, while still making physical contact with the plug of FIG. 6;

FIG. 8 is a schematic view of a second alternate embodiment for wireless handshaking disclosing two optical-activated wireless handshake plugs separated by a small distance and transmitting data between the two wireless-enabled devices (shown in outline);

FIG. 9 is a schematic view of a third alternate embodiment for wireless handshaking disclosing two magnetic proximity-based wireless handshake plugs separated by a small distance and transmitting data between the two wireless-enabled devices (shown in outline);

FIG. 10 is a schematic view of a fourth alternate embodiment for wireless handshaking disclosing two radio-frequency-based wireless handshake plugs separated by a small distance and transmitting data between the two wireless-enabled devices (shown in outline);

FIG. 11 is a section view of one example of a wireless handshake plug disclosing a single conductor used to create a communications link;

FIG. 12 is the cross-section view of FIG. 11;

FIG. 13 is a section view of a second embodiment of a wireless handshake plug having two conductors;

FIG. 14 is another embodiment of a two-conductor plug;

FIG. 15 is a cross-section view of FIG. 13;

FIG. 16 is a section view of another embodiment of a wireless handshake plug having four conductors;

FIG. 17 is a section view of another embodiment of the four-conductor plug;

FIG. 18 is the cross-section view of FIG. 16;

FIG. 19 is a section view of another embodiment of a wireless handshake plug having more than four conductors;

FIG. 20 is a cross-section view of FIG. 19;

FIG. 21 is a flow chart establishing a communications link between two wireless-enabled devices through the wireless handshaking method described in the present invention;

FIG. 22 is an alternate method of communication of FIG. 21;

FIG. 23 is a flow chart for one example of a master device logic sequence; and

FIG. 24 is a flow chart for one example of a peripheral device logic flow chart.

### BEST MODE FOR CARRYING OUT THE INVENTION

The present invention is directed to a method and a system for wireless device communication between two wireless-enabled devices, regardless if the communication is between a master and a peripheral device or between two master devices. Each device 2, whether a master device 4 (such as a PDA, cellular phone, or computer) or a peripheral device 6 (such as a keyboard, printer, or camera), includes a wireless handshake plug 10 that provides a means to accept and send at least one byte of data.

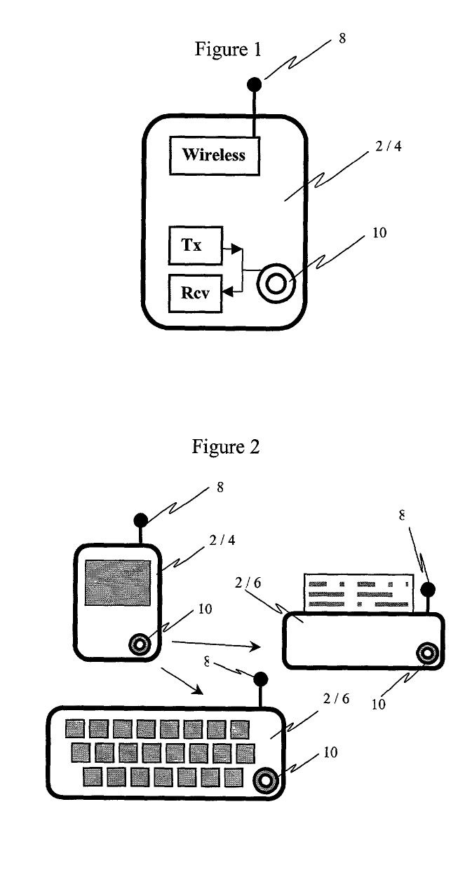

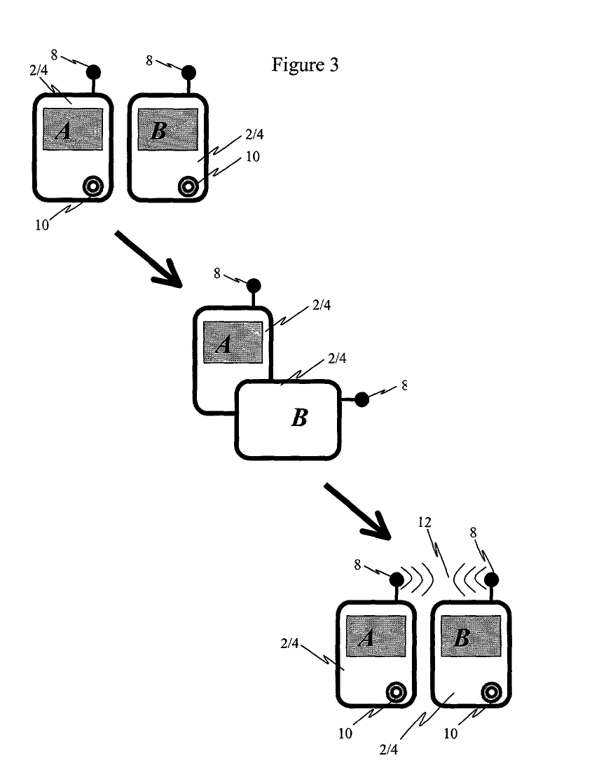

Referring to FIGS. 1-3, a wireless-enabled device 2, such as the master device 4 shown in FIG. 1, is capable of being connected to either a peripheral device 6, such as is shown in FIG. 2, or another master device 4, such as is shown in FIG. 3, by means of wireless handshaking. Wireless handshaking, as used herein, is the term used for establishing a communications link between two wireless-enabled devices such that the devices can communicate (i.e. transmit data) between each other apart from the primary wireless network to which the two devices are capable of being linked. When the wireless handshake plug of each device is brought into physical proximity with the other, handshaking takes place. The transferred handshaking data will minimally includes a wireless network address. Additional information may be transferred such as a security key or manufacturer's information. Once the link is formed, which can be within a matter of seconds, the handshaking can be discontinued and the primary wireless communication (e.g. radio-frequency communication through each device's antenna shown at “8”) can be the predominate means for wireless communication between the two devices, which is denoted as “12” in FIG. 3 once the primary wireless communication is established, thereby negating the need for the “secondary” wireless communication handshaking.

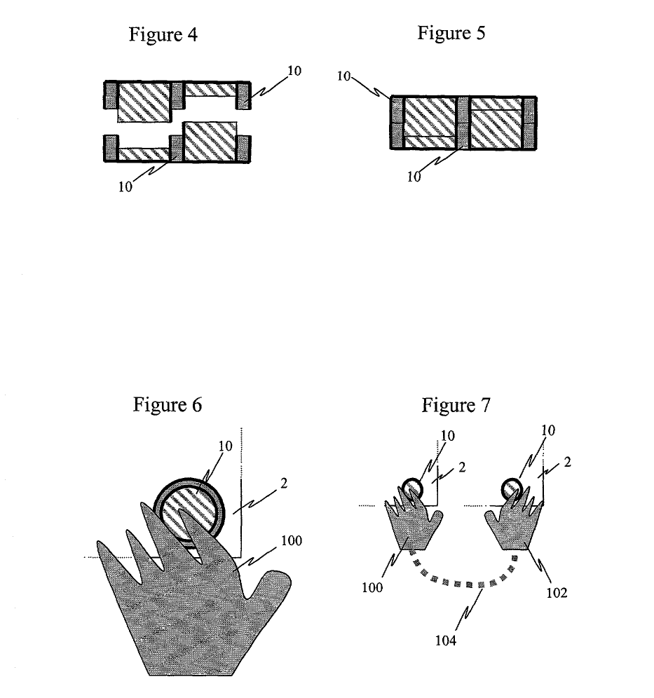

Now referring also to FIGS. 4-10, the wireless handshaking of the present invention can be accomplished in a variety of means. A first means is through direct contact between the two wireless handshake plugs. This can best be seen in FIGS. 4 and 5, where the two plugs 10 on the respective master devices of FIG. 3 are shown about to make physical contact (FIG. 4) and, then, shown making physical contact (FIG. 5). However, direct contact of the plugs is not the only means in which wireless handshaking can take place. Any means for establishing a communications link between the plugs, while being in physical proximity with each other, are encompassed in the present invention.

Referring to FIGS. 6 and 7, the human body can act as a communications path via electricity or magnetism. Here, a user may place one hand 100 (or other body part) into contact with one device's plug 10, while the other hand 102 (or other body part) contacts the other device's plug (as can be seen in FIG. 7) to complete the communications link, and, hence, communication may be transmitted and received between the two plugs (denoted at “104”). Once the user removes one of the hands, handshaking is terminated.

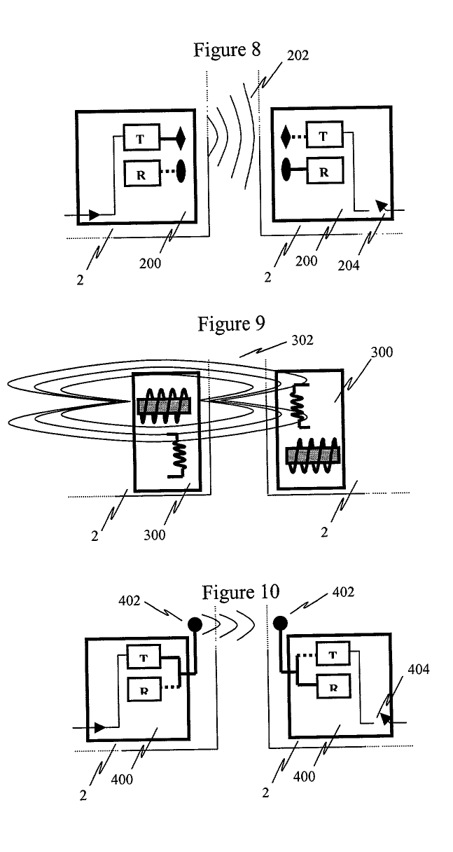

Likewise, a communications link as a means for wireless handshaking can be made through optical-based plugs 200 that are placed within physical proximity of each other, as shown in FIG. 8. Each optical-based plug contains a light source that emits a specific frequency. Each plug also includes a light detector tuned to that same frequency. Known infrared frequencies and common LED's may be used to form the optical-based plugs. The system is designed to complete the circuit when the plugs are placed within a few centimeters, e.g. approximately 5 centimeters or less, in which to make the communications link. If the physical proximity becomes too great, there is a risk of unintentional handshaking. Thus, relatively close proximity between the plugs during wireless handshaking is desired. Once the connection is made, the transmittal of handshaking a (denoted at “202”) is made from the one plug to the other. If the plug is not a “full duplex” (meaning able to transmit and receive simultaneously), then the plug will swap roles of transmitter and receiver in two-way transmission. This also will hold true for embodiments discussed below and illustrated in FIGS. 9 and 10.

An optional switch may be added to one or both of the plugs (shown schematically as 204) to further decrease the likelihood of unintentional handshaking or running down the device's power source (e.g. battery). Thus, when the switch is activated into the “on” mode, the communications link is complete and the handshaking data is transmitted through the optical-based plugs.

Referring to FIG. 9, another wireless handshaking means can be accomplished by magnetic proximity-based plugs 300, where each plug contains a magnet 302 (i.e. the transmitter) and a magnetic field decoder 304 (i.e. the receiver). During handshaking, one of the devices detects the magnet from the other device and begins transmitting handshaking data via changes to the magnet's magnetic field. The magnetic field detector receives the data. This transmission and receiving of data is denoted generally at “302”. As discussed above, the plugs 300 then swap roles of transmitter and receiver in two-way transmission, except for plugs illustrated in FIGS. 16-20 (and which are discussed more in detail below). In the event of one-way transmission of data, the magnetic field detector can decode the signal from the magnet on the other plug to complete one-way transmission.

Yet another means for establishing a communications link for wireless handshaking is through a pair of very short-range, radio-frequency transmitter and receiver plugs 400, as shown in FIG. 10. Here, each plug includes some form of receptor, such as an antenna 402, in which to receive a radio wave. Also, here, the transmitter may be triggered by a switch or magnetic-proximity device (schematically shown at 404) so that the plug R-F capacity does not interfere with the main wireless network when handshaking mode is not employed. If no such switch is installed, the R-F capacity should be very short, that is in a range of just a few centimeters. Otherwise, unintentional handshaking likely will result.

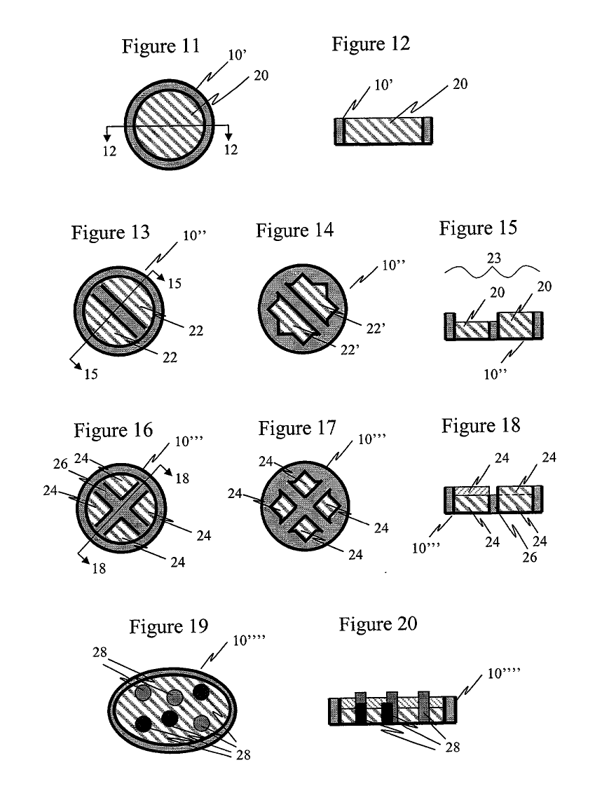

Although the wireless handshake plug may be of varying sizes and shapes, having universal capabilities (meaning that a plug can communicate with any other plug, regardless of the network system, such as 802.11a, 802.11b, or BLUETOOTH network) is desired. Moreover, the plug may contain one or more conductors. Although a single conductor plug 10′ containing a single conductor 20 can be used, such as that shown in FIGS. 11 and 12, an initial inquiry as to which device is the master device is likely needed. If both devices are master devices (such as shown in FIG. 3), then one device is chosen for initial transmission. The transmitter sends a coded signal to the receiver through the circuit containing the handshake data. The signal can be encoded using Matrix Semiconductor's 1-wire protocol or equivalent.

The more common application would include a two-conductor plug 10″, as exemplified in FIGS. 13-15, consisting of two conductors 22 for bi-directional communications. Here, there is a design benefit to the staggered profile 23 shown in FIG. 15. The staggered profile of the conductors is analogous to a traditional mechanical male/female connector. Thus, when making direct handshaking contact (e.g. FIG. 5), there is a male/female seating arrangement during contact, which makes the contact more secure and less likely to create unintentional handshaking.

Once the pair of plugs are in physical contact with each other, such as is shown in FIG. 5, the communications link is established. In the two-conductor plug form, the plugs will alternate roles of transmitter and receiver. The transmitter sends a coded signal to the receiver through the circuit containing the handshake data. The transmitter then waits to receive a reply. The original receiver becomes the new transmitter and acknowledges success or failure to the other plug and then sends its handshake data. The plugs continue to swap roles until both sides have acknowledged successful reception.

A four-conductor plug form 10′″ may also be used, such as those shown in FIGS. 16, 17, and 18, with each plug using two conductors as a conventional communications circuit. In the four connectors option, it is desirable to have each individual conductors 24 separated from the other. Therefore, the crossed dividers 26, as can be seen in FIGS. 16 and 17, are beneficial to keep the conductors separate. Multiple-conductor plugs 10″″ may also be used, such as are shown in FIGS. 19 and 20, where six conductors 28 are shown for select applications. For this application, a more conventional RS-232 serial port may be used.

The present method and system is designed to be essentially a secondary communication method/system. Only a minimal amount of data (e.g. wireless network address) is needed to create a connection over the primary communication system. Once the handshake data is successfully communicated, the primary communication system (the wireless network) can take over and the handshaking can be discontinued. However, the wireless handshaking method of the present invention can be the primary connection if more data is communicated between the two wireless-enabled devices. For example, personal or business contact information may be transmitted between the plugs and sent directly to the peripheral device, such as a wireless printer, to immediately act on such data (store, print, etc.).

To accomplish the goal of a secondary communication system between two wireless-enabled devices that are part of a wireless network, the handshaking data will transmit in less time if the data itself is small. Thus, the data format is optimally binary-encoded, with a CRC for catching errors. Alternatively, a forward error correction code can be used to both catch and correct errors.

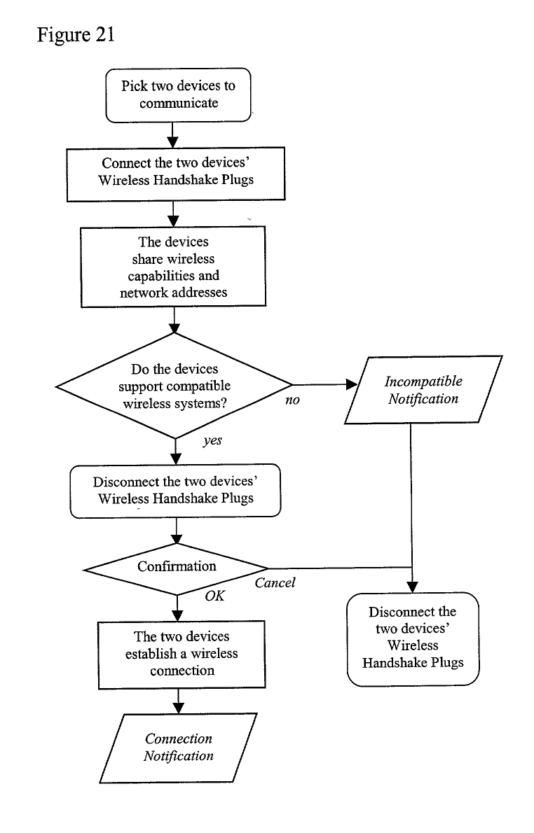

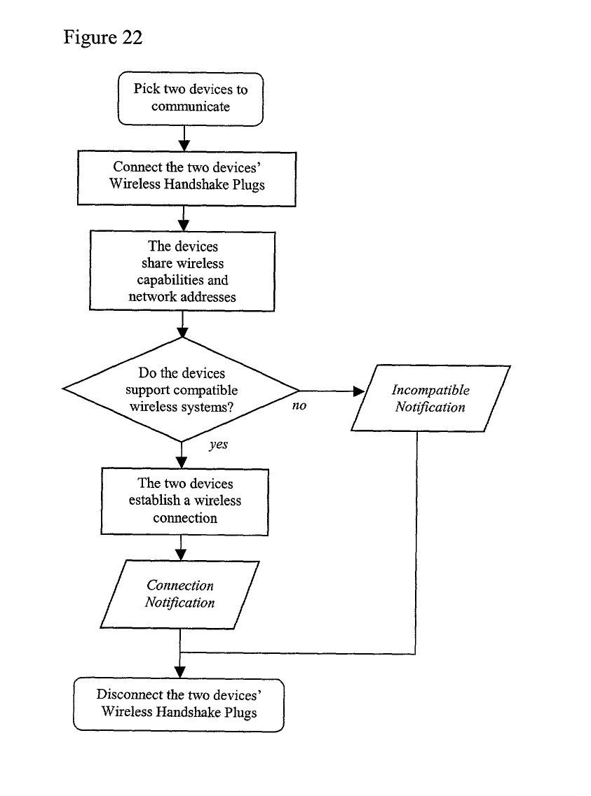

Referring to FIGS. 21 and 22, flow charts are shown for the method of the present invention. Particularly, the method includes providing the two wireless-enabled devices that are desired to communicate with each other. The two devices are then handshaked by the physical proximity of the two wireless handshake plugs in one of the described handshaking means described above. If the devices share wireless capabilities and network addresses, the question then becomes, do the devices support compatibility? If the answer is yes, then the handshake connection can be disconnected either at that point, or at some later time, as shown in FIG. 22. In some cases, there may be the benefit of a time delay to have the user actually confirm or initialize new user data, such as if a user has connected the printer before the printer automatically prints, then there would be some initialization or data entry at that point. Therefore, the flow chart of FIG. 21 might be more beneficial than that of FIG. 22. If the two devices have established a successful wireless communication, there is some successful notification to the other device. Optionally, successful notification to the user may also be made through a visible display, sound, color, flashing light, or some combination thereof. However, if there is an incompatibility issue, notification of this state would be transmitted to the other device. Again, a failure notification may also be conveyed to the user, similar to those discussed above for successful compatibility (beyond the obvious lack of connection).

There will be some devices that, for certain reasons, contain compatible wireless network systems yet still will not be able to talk to each other, e.g. two printers. The present invention does not influence the compatibility of the devices.

Each plug is shown to be physically attached to its respective wireless-enabled device. But this physical connection is not a requirement of the present invention. A plug remote to its device may be handshaked with another device's plug. A remote plug/device may be ideally situated where one device is mobile and the device requiring connection is in a fixed location. Thus, only the two plugs of the corresponding wireless-enabled devices need to be in physical proximity to each other for a communications link to be established.

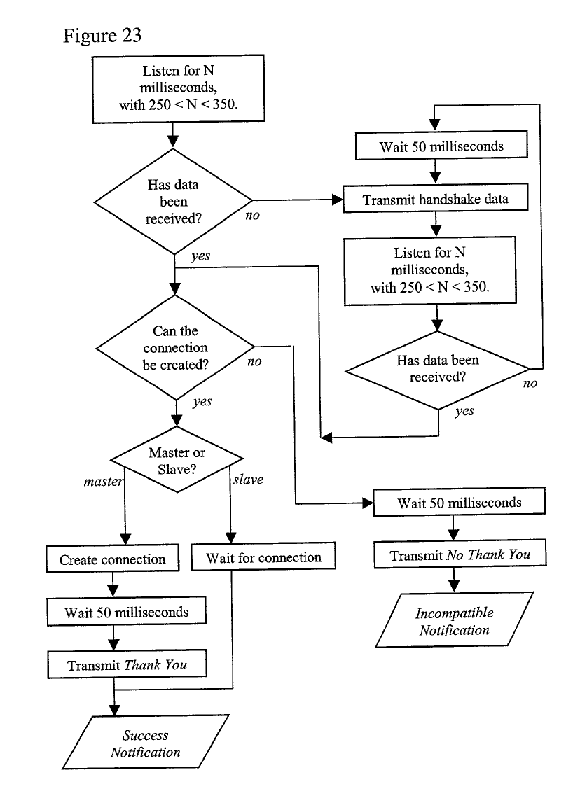

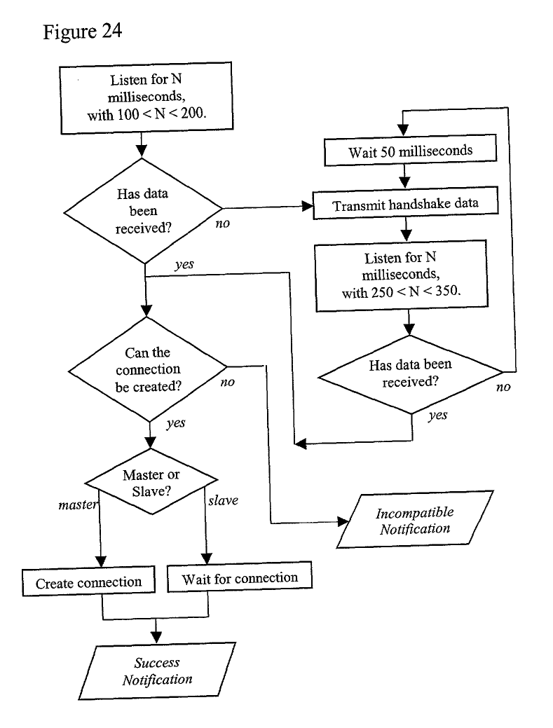

In one example, although not limited to such example, the individual processing system for wireless handshaking may be shown as configured in the flow charts of FIGS. 23 and 24. Here, the additional question can be added whether the device can be initialized as a master, as defined above, or slave (peripheral device). Therefore, it is the master device that would initiate the communication, as a slave device can only receive communication and cannot transmit. The timing on the protocol flow charts of FIGS. 23 and 24 are illustrative only and are not intended to be limiting factors.

Advantages of the present invention include that the wireless handshake plug is cost-effective, easy to use, and quick to connect. The illustrated embodiments are only examples of the present invention and, therefore, are non-limitive. It is to be understood that many changes in the particular structure, materials, and features of the invention may be made without departing from the spirit and scope of the invention. Therefore, it is the Applicants intention that his patent rights not be limited by the particular embodiments illustrated and described herein, but rather by the following claims interpreted according to accepted doctrines of claim interpretation, including the Doctrine of Equivalents and Reversal of Parts.

What is claimed is:

1. A wireless communication connection method comprising:
providing two wireless-enabled devices, wherein at least one device is a master device, each said wireless-enabled device including a wireless handshake plug, wherein each said plug is capable of receiving and sending data to the other plug;
handshaking the two wireless-enabled devices by bringing each device's plug in physical proximity with the other and transmitting handshaking data from the at least one master device plug to the other device plug such that a wireless communication connection is established.

2. The method according to claim 1 wherein the plug is capable of receiving and sending at least one bit of handshaking data.

3. The method according to claim 1 wherein the transmitted handshaking data consists of a wireless network address.

4. A secondary wireless communication connection method between two wireless-enabled devices each having a primary communication method via a wireless network, with at least one device being a master device, the method comprising:
providing a secondary communication wireless handshake plug to each wireless-enabled device, wherein each said plug is capable of receiving and sending data to the other plug;
handshaking the two handshake plugs by bringing each device's plug in physical proximity with the other, and transmitting handshaking data from the master device plug to the other device's plug such that a secondary wireless communication connection is established apart from the wireless network.

5. The method according to claim 4 wherein the primary communication method is established between the two devices after the secondary communication is established.

6. The method according to claim 5 wherein the secondary communication method is terminated after the primary communication is established.

7. The method according to claim 1 wherein the two plugs physically contact each other during handshaking.

8. The method according to claim 1 wherein the physical proximity is established by a user making physical contact with each plug to create a communications link between the two wireless-enabled devices during handshaking.

9. The method according to claim 1 wherein each plug includes a magnet and magnetic field detector that is capable of decoding handshaking data and is closely positioned to the other plug during handshaking, and wherein one wireless-enabled device detects the magnet of the other device and begins transmitting handshaking data.

10. The method according to claim 1 wherein each plug includes a short-range, radio-frequency, transmitter and receiver that is closely positioned to the other plug during handshaking and wherein the handshaking data is transmitted over one of the plug's short-range, radio-frequency transmitter.

11. The method according to claim 1 wherein each plug further includes an optical transmitter and an optical receiver, such that each plug is closely positioned to the other plug during handshaking.

12. A wireless communication connection method comprising:
providing two wireless-enabled devices communicatingly connected to a wireless network, wherein at least one device is a master device, each said wireless-enabled device including a wireless handshake plug, wherein each said plug is capable of receiving and sending data to the other plug;
means for handshaking the two wireless-enabled devices such that handshaking data is transmitted from the at least one master device plug to the other device plug and a wireless communication connection is established apart from the wireless network.

13. A wireless communication system comprising:
a master wireless-enabled device capable of transmitting and receiving data;
a peripheral wireless-enabled device capable of receiving data;
a wireless communication network; and
a pair of wireless handshake plugs, one plug corresponding to the master device and the other plug corresponding to the peripheral device; said plugs being capable of transmitting and receiving data and are capable of being brought into physical proximity to each other.

14. A wireless communication system comprising:
two master wireless-enabled devices capable of transmitting and receiving data;
a wireless communication network; and
a pair of wireless handshake plugs, one plug corresponding each device; said plugs being capable of transmitting and receiving data and being in close proximity to each other in order to transmit and receive data from one device to the other.

15. The system according to claim 13 wherein the plugs can transmit and receive at least one byte of data.

16. The system according to claim 14 wherein the plugs can transmit and receive at least one byte of data.

17. The system according to claim 13, wherein each plug is physically connected to its corresponding device.

18. The system according to claim 14, wherein each plug is physically connected to its corresponding device.

19. The system according to claim 13, wherein at least one plug is physically remote from its corresponding device.

20. The system according to claim 14, wherein at least one plug is physically remote from its corresponding device.
